(19) United States
(12) Patent Application Publication
(10) Pub. No.: US 2006/0089819 A1
(43) Pub. Date: Apr. 27, 2006

(54) Chipset activation

(76) Inventor: Scott P. Dubal, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/973,160

(22) Filed: Oct. 25, 2004

(51) Int. Cl. G21C 17/00

(52) U.S. Cl. 702/183

(57) ABSTRACT

A method and system are disclosed. In one embodiment the method comprises a first device determining whether a second device is permitted to be activated, the first device activating the second device if the second device is permitted to be activated, and the first device reducing the functionality of the second device if the second device is not permitted to be activated.

### FIELD OF THE INVENTION

The invention relates to activating a chipset.

### BACKGROUND OF THE INVENTION

Modern operating systems such as Microsoft® Windows XP require activation through a secure registration certificate sent from the client operating system, directly to Microsoft via the Internet. This allows Microsoft to see if more than one copy of the operating system is being used and gives Microsoft the ability to be able to provide better customer service.

Intel® Corporation has current motherboard technology, Intel® Active Management Technology (AMT), as referred to in the whitepaper Intel® Active Management Technology, August 2004, http://www.intel.com/business/bss/products/client/active_mgmt.pdf, that provides BIOS and chipset-level services and asset management information. Some of these services and data include remote management and diagnostics capabilities, hardware failure detection, and electronic asset tags among others. All asset management information is stored in a secure area of the BIOS's non-volatile memory that a system admin cannot access. In addition, the AMT agent in the BIOS also contains a small HTTP and XML web server for communication to 3rd party management software that alerts system administrators and other IT personnel. AMT technology features an out-of-band link that is independent of the operating system, allowing IT managers to access a system even if the operating system is inoperative.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of one embodiment of a computer system utilized to activate a chipset.

FIG. 2 is a block diagram of one embodiment of the components comprising a chipset activation system.

FIG. 3 is a flow diagram of one embodiment of a process for activating a chipset.

FIG. 4 is a flow diagram of another embodiment of a process for activating a chipset.

### DETAILED DESCRIPTION OF THE INVENTION

Embodiments of a method to activate a chipset are disclosed. In the following description, numerous specific details are set forth. However, it is understood that embodiments may be practiced without these specific details. In other instances, well-known elements, specifications, and protocols have not been discussed in detail in order to avoid obscuring the present invention.

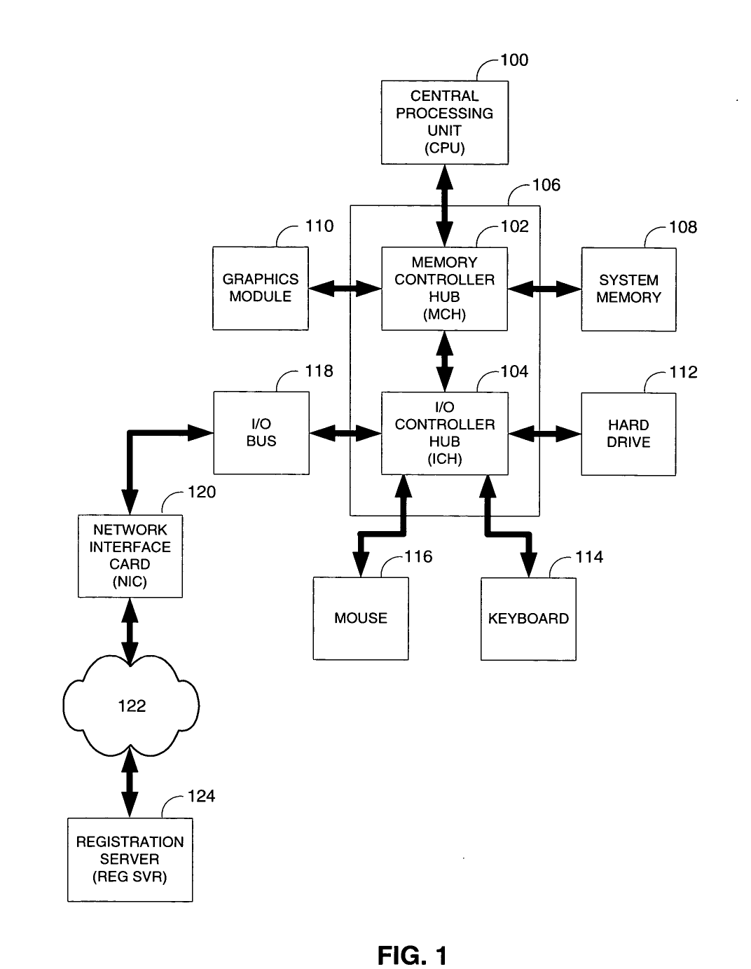

FIG. 1 is a block diagram of one embodiment of a computer system utilized to activate a chipset. The computer system includes a central processing unit (CPU) 100, a memory controller hub (MCH) 102, and an I/O controller hub (ICH) 104 that, in one embodiment, comprise a chipset 106. The term “chipset” is a common term used to refer to a motherboard configuration of one or more chips, such as the MCH and ICH chips. The MCH and ICH are commonly referred to as the northbridge and the southbridge, which when combined, form a chipset. The chipset controls much of the information passed across one or more buses on a motherboard (such as an I/O bus, a dedicated graphics bus, and a memory bus, among others). In one embodiment, the CPU 100 is coupled to the MCH 102 via a host bus and to system memory 108. System memory may comprise one or more of synchronous dynamic random access memory (SDRAM), double data rate SDRAM (DDR-SDRAM), or one of many other formats of main system memory. In one embodiment, the MCH 102 is coupled to a graphics module 110. In different embodiments, the graphics module is a Peripheral Component Interconnect (PCI) Express graphics card or an Accelerated Graphics Port (AGP) graphics card. In one embodiment, the ICH 104 is coupled to a hard drive 112, a keyboard controller 114, a mouse controller 116, and an I/O bus 118. In different embodiments, the ICH 104 may also be coupled to any number of I/O devices, buses, and/or other controllers. In one embodiment, a network interface card (NIC) 120 is coupled to the I/O bus 118. In one embodiment, the NIC 120 is coupled to a network 122. In different embodiments, the network 122 may be the Internet, an intranet, or another information network. In different embodiments, the NIC 120 may be coupled to the network 122 through a local area network (LAN) topology, a wide area network (WAN) topology, a wireless network topology, or any other applicable network topology that would allow the computer system access to the network 122. In one embodiment, a registration server (REG SVR) 124 is also coupled to the network 122.

In one embodiment, the chipset 106 must be activated to be operational. In another embodiment, the chipset 106 is operational with or without activation, but requires activation to enable one or more chipset functions. In one embodiment, the chipset 106 requires activation through an online registration process. In this embodiment, the REG SVR 124 has access to a database of all manufactured chipsets and their corresponding registration information. When the computer system containing the chipset 106 is booted for the first time by a user, the computer system checks with the REG SVR 124 to determine if the chipset 106 has been activated already. If the chipset 106 has not been activated, an attempt to automatically connect to the REG SVR 124 over the network 122 may be made. The REG SVR 124 may be able to communicate information to the computer system that specifies whether the chipset 106 is allowed to be activated or not. The computer system sends a request to the REG SVR 124, the REG SVR 124 then sends a communication back to the computer system with a response to the request (i.e. either allowing or not allowing the chipset 106 to be activated). Thus, in this embodiment, the chipset 106 may then be activated if allowance was given by the REG SVR 124. Otherwise, if the chipset has not been allowed activation, the chipset may be put into a reduced functionality mode. In one embodiment, the reduction in functionality may include reducing the operating frequency of the chipset. In another embodiment, the reduction in functionality may include disabling one or more functions associated with the chipset. In yet another embodiment, the reduction in functionality may include entirely disabling the chipset 106 from further use.

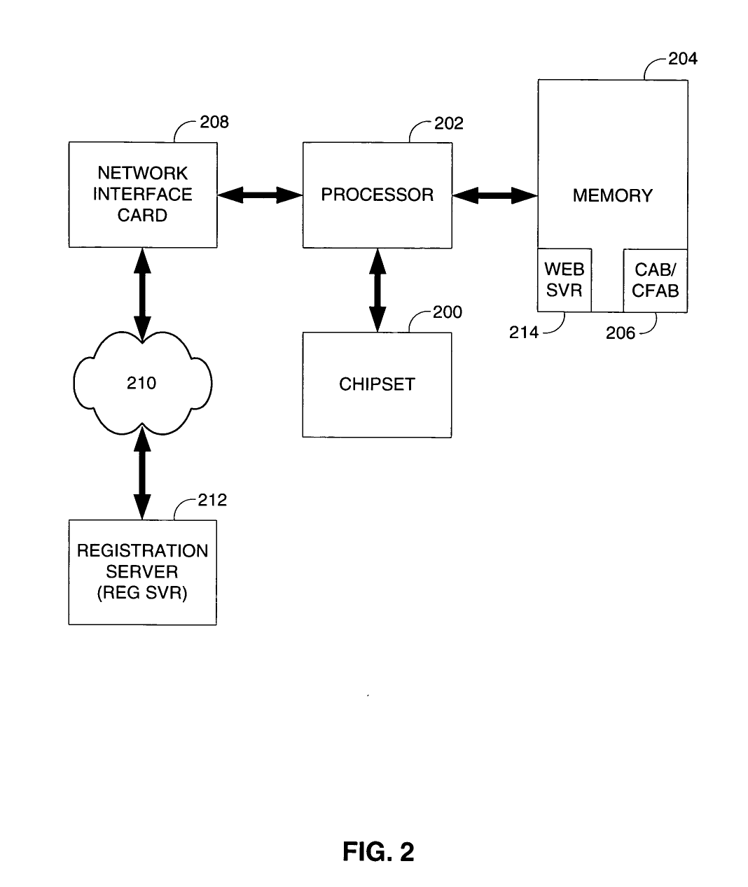

FIG. 2 is a block diagram of one embodiment of the components comprising a chipset activation system. In one embodiment, the chipset activation system is incorporated as a subsystem within a computer system (such as a desktop or laptop computer system). A chipset 200 is coupled to a processor 202. The processor is coupled to a memory 206 and a NIC 208. In one embodiment, the memory 206 is a secured segment of memory within the Basic Input-Output System (BIOS). In other embodiments, the memory 206 may be a shared memory, a dedicated memory, memory on the processor die, and/or one or more other valid memory arrangements. In one embodiment, a chipset activation bit (CAB) 206 is stored within the memory 204. In another embodiment, the CAB 206 is a bit within a register contained in the chipset 200. In one embodiment, the NIC 208 is coupled to a network 210 and has communication access to a REG SVR 212 also coupled to the network 210. In one embodiment, the processor 202 is dedicated to processing information related to the assets in the computer system. In one embodiment, the processor is a component of an Intel® Active Management Technology subsystem incorporated in the computer system. In one embodiment, the assets within the computer system may include hardware components within the computer system such as the CPU, the chipset, the system memory, and any peripheral cards.

In one embodiment, when the computer system is booted for the first time the processor 202 attempts to read the CAB 206 within the memory 204 to determine the activation status of the chipset 200. In one embodiment, if the chipset has not been activated the processor 202 then attempts to communicate with the REG SVR 212 to ascertain whether the chipset is allowed to be activated. In one embodiment, the processor 202 attempts to send an activation request to the REG SVR 212. In one embodiment, the memory stores code for a small HTTP and/or XML web server (WEB SVR) 214 to effectively communicate with the REG SVR 212. In this embodiment, the processor 202 executes the WEB SVR 214 code and the WEB SVR 214 allows the processor 202 to communicate using the NIC 208 with the REG SVR 212 across the network 210.

If the REG SVR 212 can be contacted, then the activation request sent by the processor 202 is then processed by the REG SVR 212. In one embodiment, the activation request includes identification information that allows the REG SVR 212 to identify the unique chipset 200 in the computer system making the request. The REG SVR 212 then processes the activation request, determines whether the chipset 200 is allowed to be activated, and sends a response back to the processor 202. In one embodiment, the response sent to the processor 202 consists of either a “yes” (i.e. “activate”) or “no” (i.e. “do not activate”) communication. In one embodiment, if a “yes” value is received from the REG SVR 212, the processor 202 permanently sets the CAB 206 to active and this process activation determination process will not be necessary again. In another embodiment, if a “no” value is received from the REG SVR 212, the processor 202 sets the CAB 206 to inactive. In one embodiment, when the CAB 206 is set to inactive the chipset 200 is disabled. In another embodiment, when the CAB 206 is set to inactive the chipset 200 is placed in a reduced functionality state. In yet another embodiment, the “no” value may eventually change to a “yes” value. Thus, in this embodiment, if the CAB 206 is set to inactive the processor 202 (utilizing the WEB SVR 214) will continue to poll the REG SVR 212 at each system boot to determine if the REG SVR 212 has changed the status for allowing the chipset 200 to be activated.

In one embodiment, if the REG SVR 212 cannot be contacted, then the chipset activation request is queued. In one embodiment, if the request is queued the processor 202 (utilizing the WEB SVR 214) checks for network connectivity each time the computer system is booted. Once connected to a network, the processor 202 (utilizing the WEB SVR 214) attempts to contact the REG SVR 212. In one embodiment, the chipset 200 operates in a reduced functionality state until the processor 202 verifies with the REG SVR 212 that the chipset 200 is allowed to be activated. Again, in different embodiments, reducing the functionality of the chipset 200 may include a reduction in the chipset's operational frequency, disabling an I/O bus coupled to the chipset 200, disabling an integrated graphics processor in the chipset 200, or disabling or modifying any other function of the chipset 200.

In one embodiment, when the processor 202 sends an activation request to the REG SVR 212, the REG SVR 212 in turn registers the chipset and stores a registration file in the chipset database. In this embodiment, once the chipset has been activated the processor 202 (utilizing the WEB SVR 214) can periodically check with the REG SVR 212 for any critical BIOS patches, updates, and other important communication events regarding the chipset.

In another embodiment, the response sent by the REG SVR 212 to the processor 202 includes chipset functionality level information. In this embodiment, the REG SVR 212 has functionality level information associated with each unique chipset identifier. The functionality level specifies the set of functions on the chipset 200 that are allowed to be activated (i.e. enabled). In different embodiments, the set of chipset functions that may or may not be allowed to be activated include the operational frequency of the chipset 200, a graphics processor integrated within the chipset 200, or any other functional aspect of the chipset 200 which may be enabled or disabled. In one embodiment, the chipset functionality level response sent to the processor 202 includes information regarding the activation of one or more chipset functions and each of the chipset functions is associated with a unique chipset function activation bit (CFAB) 206 located in the memory 204.

In this embodiment, when the computer system is booted for the first time the processor 202 attempts to check each CFAB 206 located within the memory 204 to determine the activation status of each chipset function. In one embodiment, if a particular chipset function has not been activated the processor 202 then attempts to communicate with the REG SVR 212 to ascertain whether the chipset function is allowed to be activated. The processor 202 attempts to send a chipset function activation request to the REG SVR 212.

If the REG SVR 212 can be contacted, then the chipset function activation request sent by the processor 202 is then processed by the REG SVR 212. In one embodiment, the chipset function activation request includes identification information that allows the REG SVR 212 to identify the chipset 200 in the computer system making the request from all other like chipsets. The REG SVR 212 then processes the chipset function activation request, determines whether the chipset function in question is allowed to be activated, and sends a response back to the processor 202. In one embodiment, the response sent to the processor 202 consists of either a “yes” (i.e. “activate”) or “no” (i.e. “do not activate”) communication. In one embodiment, if a “yes” value is received from the REG SVR 212, the processor 202 permanently sets the CFAB 206 to active and this chipset function activation determination process will not be necessary again. In another embodiment, if a “no” value is received from the REG SVR 212, the processor 202 sets the CFAB 206 to inactive. In one embodiment, when the CFAB 206 is set to inactive the chipset function is disabled. In another embodiment, the “no” value may eventually change to a “yes” value. Thus, in this embodiment, if the CFAB 206 is set to inactive the processor 202 (utilizing the WEB SVR 214) will continue to poll the REG SVR 212 at each system boot to determine if the REG SVR 212 has changed the status for allowing the chipset function to be activated. In another embodiment, if the CFAB 206 is set to inactive the processor 202 (utilizing the WEB SVR 214) will continue to poll the REG SVR 212 at predefined intervals of time (e.g. once an hour) to determine if the REG SVR 212 has changed the status for allowing the chipset function to be activated.

If the REG SVR 212 cannot be contacted, then the chipset function activation request may be queued internally into the system. In one embodiment, the processor 202 (utilizing the WEB SVR 214) checks for network connectivity each time the computer system is booted. Once connected to a network, the processor 202 (utilizing the WEB SVR 214) attempts to contact the REG SVR 212. In one embodiment, the chipset 200 operates with the function in question inactive until the processor 202 verifies with the REG SVR 212 that the chipset function is allowed to be activated.

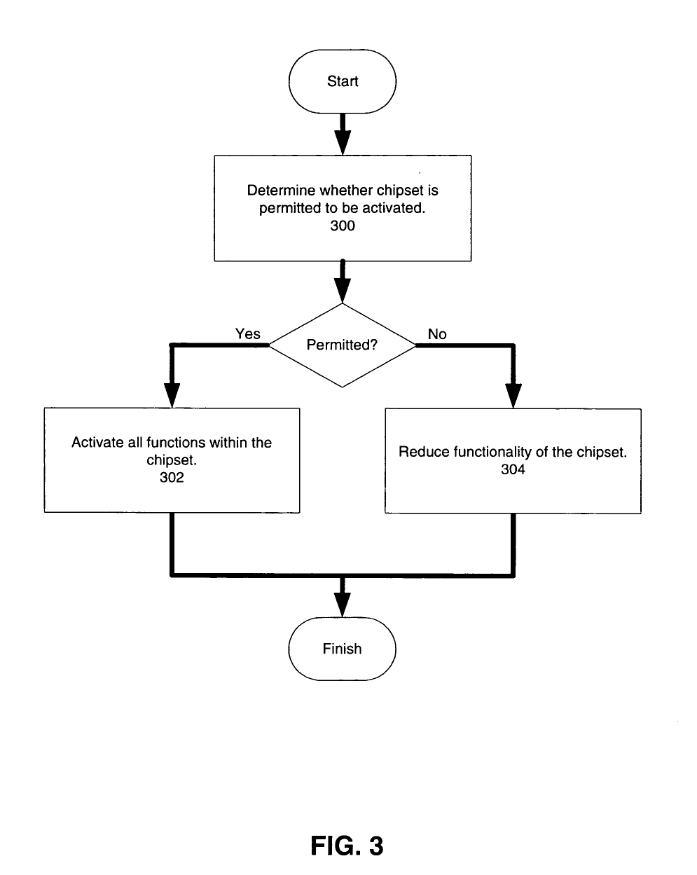

FIG. 3 is a flow diagram of one embodiment of a process for activating a chipset. The process is performed by processing logic that may comprise hardware (circuitry, dedicated logic, etc.), software (such as is run on a general purpose computer system or a dedicated machine), or a combination of both. Referring to FIG. 3, the process begins by processing logic determining whether a chipset is permitted to be activated (processing block 300). In one embodiment, processing logic checks to see if a chipset activation bit has been set to determine whether the chipset is permitted to be activated. In this embodiment, if the chipset activation bit has been set then the chipset is permitted to be activated. If the chipset activation bit has not been set then the chipset is not permitted to be activated. If the chipset is permitted to be activated then processing logic activates all functions within the chipset (processing block 302). If the chipset is not permitted to be activated then processing logic reduces the functionality of the chipset (processing block 304). In different embodiments, reducing the functionality of the chipset may include a reduction in the chipset's operational frequency, disabling an I/O bus coupled to the chipset, disabling an integrated graphics processor, or disabling or modifying any other function of the chipset.

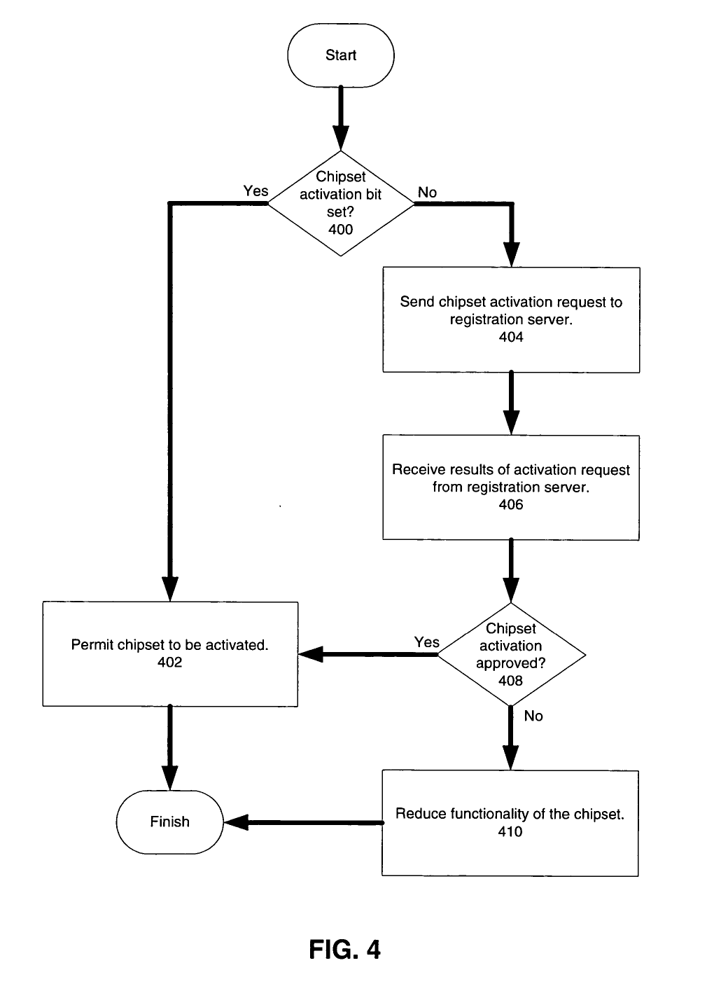

FIG. 4 is a flow diagram of another embodiment of a process for activating a chipset. The process is performed by processing logic that may comprise hardware (circuitry, dedicated logic, etc.), software (such as is run on a general purpose computer system or a dedicated machine), or a combination of both. Referring to FIG. 4, the process begins by processing logic determining whether a chipset activation bit has been set (processing block 400). In one embodiment, this processing logic is located in the processor. In another embodiment, this processing logic is programmed into the software stored into memory and then run by the processor. In different embodiments, the chipset activation bit may be located in a register on the chipset, in memory coupled to the chipset, in a ROM, in a BIOS, or in any other storage location. In one embodiment, the chipset activation bit is in a secured location that may not be tampered with by an end user. If the chipset activation bit has been set, then processing logic permits the chipset to be activated (processing block 402). In one embodiment, this processing logic is located in the processor. In another embodiment, this processing logic is programmed into the software stored into memory and then run by the processor. In one embodiment, processing logic activates the chipset by setting the chipset activation bit and thus allowing the chipset to activate and boot with full functionality.

If the chipset activation bit has not been set, then processing logic sends a chipset activation request to a registration server (processing block 404). In one embodiment, this processing logic is located in the processor. In another embodiment, this processing logic is programmed into the software stored into memory and then run by the processor. In different embodiments, the registration server may be located on a local network, on a wireless network, on the Internet, or on any other form of network that the processing logic can communicate across. In one embodiment, chipset activation request includes identification information that allows the registration server to identify the unique chipset in the computer system making the request. In one embodiment, the registration server contains a database of all manufactured chipsets and their corresponding registration information. In another embodiment, the registration server communicates with a third party database containing the corresponding registration information for the chipset. Once the activation request has been received, the registration server sends the results of the activation request back to processing logic.

Therefore, processing logic next receives results of activation request from the registration server (processing block 406). In one embodiment, this processing logic is located in the processor. In another embodiment, this processing logic is programmed into the software stored into memory and then run by the processor. In one embodiment, the results that return from the registration server consist of either a “yes” (i.e. activate, approve) or “no” (i.e. do not activate, do not approve) communication. Next, processing logic checks to see whether the chipset activation request was approved by the registration server (processing block 408). In one embodiment, this processing logic is located in the processor. In another embodiment, this processing logic is programmed into the software stored into memory and then run by the processor. If the chipset activation was approved then processing logic permits the chipset to be activated (processing block 402). Alternatively, if the chipset activation was not approved then processing logic reduces the functionality of the chipset (processing block 410). In one embodiment, this processing logic is located in the processor. In another embodiment, this processing logic is programmed into the software stored into memory and then run by the processor. In different embodiments, reducing the functionality of the chipset may include a reduction in the chipset's operational frequency, disabling an I/O bus coupled to the chipset, disabling an integrated graphics processor, or disabling or modifying any other function of the chipset.

Thus, embodiments of a method to activate a chipset are disclosed. Although the method is described with specific reference to a chipset, the same method can be employed for any piece of hardware that has similar functional capabilities such as a central processing unit or a graphics processor. Additionally, these embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
a first device determining whether a second device is permitted to be activated;
the first device activating the second device if the second device is permitted to be activated; and
the first device reducing the functionality of the second device if the second device is not permitted to be activated.

2. The method of claim 1, wherein determining whether a second device is permitted to be activated further comprises:
the first device permitting the second device to be activated if a device activation bit is set; and
if the activation bit is not set, the first device determining whether the device activation bit is permitted to be set.

3. The method of claim 2, wherein determining whether the activation bit is permitted to be set further comprises:
the first device sending a device activation request to a registration server; and
the first device receiving a device activation approval response or a device activation rejection response from the registration server in response to the device activation request.

4. The method of claim 3, wherein the activation request comprises a device identification number to identify the second device.

5. The method of claim 4, further comprising:
the registration server receiving the activation request from the first device;
the registration server checking a registration database with the device identification number to verify if the second device is permitted to be activated; and
the registration server sending a response to the first device that specifies whether to allow or not allow activation of the second device based on the information within the registration database.

6. The method of claim 1, wherein reducing the functionality of the second device if the second device is not permitted to be activated further comprises reducing the operating frequency of the second device.

7. The method of claim 1, wherein reducing the functionality of the second device if the second device is not permitted to be activated further comprises disabling an internal function within the second device.

8. The method of claim 1, wherein reducing the functionality of the second device if the second device is not permitted to be activated further comprises disabling the second device.

9. The method of claim 3, wherein the second device comprises a chipset.

10. A method, comprising:
a first device determining whether a function within a second device is permitted to be activated;
the first device activating the function within the second device if it is permitted to be activated; and
the first device not activating the function within the second device if it is not permitted to be activated.

11. The method of claim 10, wherein determining whether a function within a second device is permitted to be activated further comprises:
permitting the function within the second device to be activated if a function activation bit is set; and
if the function activation bit is not set, determining whether the function activation bit is permitted to be set.

12. The method of claim 11, wherein determining whether the function activation bit is permitted to be set further comprises:
the first device sending a function activation request to a registration server; and
the first device receiving a function activation approval response or a function activation rejection response from the registration server in response to the function activation request.

13. The method of claim 12, wherein the activation request comprises:
a device identification number to identify the second device; and
a function identification number to identify the second device's function.

14. The method of claim 13, further comprising:
the registration server receiving the activation request from the first device;
the registration server checking a registration database with the device identification number to verify if the second device is permitted to be activated; and
the registration server sending a response to the first device that specifies whether to allow or not allow activation of the second device's function based on the information within the registration database.

15. The method of claim 12, wherein the second device comprises a chipset.

16. A system, comprising:
a bus;
a processor coupled to the bus;
a chipset coupled to the bus; and
a memory coupled to the bus, the memory adapted for storing instructions, which upon execution by the processor:
determines whether the chipset is permitted to be activated;
activates the chipset if the chipset is permitted to be activated; and
reduces the functionality of the chipset if the chipset is not permitted to be activated.

17. The system of claim 16, wherein the processor:
permits the chipset to be activated if a chipset activation bit is set; and
determines whether the chipset activation bit is permitted to be set if the chipset activation bit is not set.

18. The system of claim 17, wherein the processor:
sends a chipset registration request to a registration server; and
receives a chipset activation approval response or a chipset activation rejection response from the registration server in response to the chipset registration request.

19. The system of claim 16, wherein reducing the functionality of the chipset comprises reducing the operating frequency of the chipset.

20. The system of claim 16, wherein reducing the functionality of the chipset comprises disabling an internal function within the chipset.

21. The system of claim 16 wherein reducing the functionality of the chipset comprises disabling the chipset.

22. The system of claim 16, wherein the memory comprises a protected segment of the Basic Input-Output System (BIOS).

23. A system, comprising:
a bus;
a chipset coupled to the bus; and
a processor coupled to the bus, the processor operable to;
determine whether the chipset is permitted to be activated;
activate the chipset if the chipset is permitted to be activated; and
reduce the functionality of the chipset if the chipset is not permitted to be activated.

24. The system of claim 23, wherein the processor is further operable to:
permit the chipset to be activated if a chipset activation bit is set; and
determine whether the chipset activation bit is permitted to be set if the chipset activation bit is not set.

25. The system of claim 24, further comprising a memory, wherein the memory is operable to store instructions, which upon execution by the processor:
sends a chipset registration request to a registration server; and
receives a chipset activation approval response or a chipset activation rejection response from the registration server in response to the chipset registration request.

26. The system of claim 25, wherein the memory comprises a protected segment of the Basic Input-Output System (BIOS).

27. The system of claim 23, wherein reducing the functionality of the chipset comprises reducing the operating frequency of the chipset.

28. The system of claim 23, wherein reducing the functionality of the chipset comprises disabling an internal function within the chipset.

29. The system of claim 23 wherein reducing the functionality of the chipset comprises disabling the chipset.
